(19) United States
(12) Patent Application Publication
(10) Pub. No.: US 2025/0249538 A1
(43) Pub. Date: Aug. 7, 2025

(54) LASER-BEAM BUTT WELDING METHOD

(71) Applicant: JFE Steel Corporation, Chiyoda-ku, Tokyo (JP)

(72) Inventors: Asato HARA, Chiyoda-ku, Tokyo (JP); Nao KAWABE, Chiyoda-ku, Tokyo (JP); Katsutoshi TAKASHIMA, Chiyoda-ku, Tokyo (JP)

(73) Assignee: JFE Steel Corporation, Chiyoda-ku, Tokyo (JP)

(21) Appl. No.: 18/856,197

(22) PCT Filed: Jan. 6, 2023
(86) PCT No.: PCT/JP2023/000146

§ 371 Date: Oct. 11, 2024

(30) Foreign Application Priority Data
Apr. 26, 2022 (JP) 2022-072530

(51) Int. Cl. B23K 28/02; B23K 26/26; B23K 101/18; B23K 103/04

(52) U.S. Cl. CPC B23K 28/02; B23K 26/26; B23K 2101/18; B23K 2103/04

(57) ABSTRACT

A laser-beam butt welding method is provided in which cut surfaces of two steel sheets each having a sheet thickness t of 0.1 to 3.0 mm are placed in contact with each other and butted together, and then the two steel sheets are welded together by feeding a filler to the butted part and emitting a laser beam onto the butted part so as to melt the filler and the steel sheets. In this method, the cut surfaces of the two steel sheets are formed by laser cutting so as to have inclination angles θ exceeding 20° but not exceeding 60° in the same direction relative to a plane perpendicular to surfaces of the steel sheets, and to have a width a of 3.0 mm or less in a steel-sheet longitudinal direction, and then the cut surfaces of the two steel sheets are butted together in a state of a scarf joint and welded together. Thus, a high-quality butt-weld joint can be produced even in thin steel sheets having a small sheet thickness and a large width.

### CROSS REFERENCE TO RELATED APPLICATIONS

This is the U.S. National Phase application of PCT/JP2023/000146, filed Jan. 6, 2023 which claims priority to Japanese Patent Application No. 2022-072530, filed Apr. 26, 2022, the disclosures of these applications being incorporated herein by reference in their entireties for all purposes.

### FIELD OF THE INVENTION

The present invention relates to a laser-beam butt welding method in which cut surfaces of two thin steel sheets are butted together and the butted part is irradiated with a laser beam to weld the steel sheets together.

### BACKGROUND OF THE INVENTION

In recent years, it has been common practice in production lines of iron and steel products, particularly thin steel sheets, such as a pickling line, a cold-rolling line, an annealing line, a refining line, and a surface treatment line, to continuously process a thin steel sheet wound into a coil shape by threading, while unwinding it through the lines from the viewpoint of improving the quality, increasing the productivity, etc. In such a continuous processing line, a tail end of a preceding thin steel sheet and a leading end of a succeeding thin steel sheet need to be joined together on an entry side by some means.

As the joining means, flash butt welding, lap seam welding, etc. have been conventionally often used, while laser beam welding has been increasingly mainly used for steel sheets that contain large amounts of alloy ingredients and are inferior in brittleness. In this laser beam welding, a tail end of a preceding thin steel sheet and a leading end of a succeeding thin steel sheet are cut by a shearing machine included in a welding device to adjust the accuracy of the end surfaces of portions to be welded, and then these end surfaces are butted together and subjected to welding.

However, when performing this cutting process by a mechanical method, such as shearing, it is difficult to make the cut surfaces perfectly straight. In addition, shear drop and burr occur in the cut end surfaces, so that no matter how much the cutting accuracy is increased, it is impossible to reduce the gap between the butted steel sheets to 0 (zero). To deal with this problem, welding is performed by supplying a filler material (filler) to the gap between the steel sheets (e.g., see Patent Literatures 1 and 2).

However, as lasers used for laser beam welding of steel sheets generally have a power of 10 kW or less and a beam diameter of about 0.4 to 0.6 mm, it is not easy to accurately direct the laser beam to the portions to be welded. Therefore, weaving a laser beam emitted onto the portions to be welded so as to traverse the butted part of the steel sheets is performed (e.g., see Patent Literatures 3 to 5).

However, the technologies disclosed in Patent Literatures 3 and 4 are technologies that do not involve supplying a filler to portions to be welded, and cannot be applied to a case where a filler is supplied. One problem with the technology disclosed in Patent Literature 5 is that it cannot stably produce a weld joint with excellent mechanical strength when the gap between the butted steel sheets is large or when the gap varies in a sheet width direction.

As a solution to this problem, Patent Literature 6 discloses a technology in which one of steel sheets to be butted together is vertically reversed so as to reduce the gap between the butted steel sheets as much as possible. Patent Literature 7 also discloses a method in which opposing end surfaces (cut surfaces) of two sheet-like materials to be butt-welded are formed into inclined surfaces that are inclined in the same direction relative to a plane perpendicular to the surfaces of the materials, and these opposing end surfaces are butted and then welded together by emitting a laser beam onto the butted part from substantially vertically above.

### PATENT LITERATURE

Patent Literature 1: JP-H03-133587A
Patent Literature 2: JP-H08-290281A
Patent Literature 3: JP-2014-205166A
Patent Literature 4: International Publication No. WO 2020/179029
Patent Literature 5: JP-2003-170284A
Patent Literature 6: JP-2001-205432A
Patent Literature 7: JP-2012-135796A

### SUMMARY OF THE INVENTION

However, when the welding methods disclosed in Patent Literatures 6 and 7 are applied to joining thin steel sheets that have a small sheet thickness and a large width, it is difficult to obtain a sound joint along the entire sheet widths of the thin steel sheets. In particular, in thin steel sheets with a sheet thickness of 1.0 mm or less, it is difficult to prevent weld fracture in a continuous processing line.

Having been developed in view of the above-described problems with the conventional technologies, aspects of the present invention aim to propose a laser-beam butt welding method that can produce a high-quality butt-weld joint even in thin steel sheets having a small sheet thickness and a large width.

To solve the above challenge, the present inventors vigorously conducted studies with a focus on particularly the technology of Patent Literature 7 described above. As a result, the main reason why a sound weld could not be formed by this conventional technology turned out to be that the technology was one intended for tailored blank materials as described above, and that therefore the cut surfaces of the sheet-like materials to be butt-welded were not formed with high accuracy. Moreover, it was found that the inclination angles of the opposing end surfaces relative to the vertical plane were inappropriate, which made burn-through likely to occur in thin steel sheets with a sheet thickness of 1.0 mm or less. To solve the above-described problems with the conventional technologies, it is effective to form the cut surfaces of the steel sheets to be butted together with high accuracy by using laser cutting, and it is necessary to set the inclination angles of the cut surfaces of the steel sheets to be butted together to an appropriate range. These findings led to the development of the present invention.

Aspects of the present invention based on the above findings include a laser-beam butt welding method in which cut surfaces of two steel sheets each having a sheet thickness t of 0.1 to 3.0 mm are placed in contact with each other and butted together, and then the two steel sheets are welded together by feeding a filler to the butted part and emitting a laser beam onto the butted part so as to melt the filler and the steel sheets. This method is characterized in that: the cut surfaces of the two steel sheets are formed by laser cutting so as to have inclination angles θ exceeding 20° but not exceeding 60° in the same direction relative to a plane perpendicular to surfaces of the steel sheets, and to have a width a of 3.0 mm or less in a steel-sheet longitudinal direction; and then, the cut surfaces of the two steel sheets are butted together in a state of a scarf joint and welded together.

The laser-beam butt welding method according to aspects of the present invention is characterized in that a minimum melting width w of a weld to be formed by the laser beam irradiation is set to be not less than 0.7 times the width a of the cut surfaces in the steel-sheet longitudinal direction.

The laser-beam butt welding method according to aspects of the present invention is characterized in that the laser beam is emitted onto the butted part of the butted steel sheets while being weaved such that an irradiation trajectory has a spiral shape.

The laser-beam butt welding method according to aspects of the present invention is characterized in that a weaving width b of the laser beam is set to 2.5 mm or less.

The laser-beam butt welding method according to aspects of the present invention is characterized in that an amount of heat input of the laser beam per unit sheet thickness and unit weld length is set to 10000 KJ/m² or more.

According to aspects of the present invention, the cut surfaces of the two steel sheets are formed with appropriate inclination angles in the same direction relative to the plane perpendicular to the surfaces of the steel sheets, and these cut surfaces are butted together so as to overlap in the form of a scarf joint before being welded together. This makes it possible to form a sound weld by absorbing adverse influences on welding of variation in the gap at the butted part between the thin steel sheets in the sheet width direction and shape defects of the thin steel sheets. In particular, the welding method according to aspects of the present invention is effective for preventing burn-through during welding, and thus can produce a high-quality butt-laser-weld joint even in steel sheets with a sheet thickness of less than 1.0 mm, which have been difficult to weld by the conventional technologies. Therefore, aspects of the present invention can not only reduce the time of re-welding due to poor welding of thin steel sheets but also prevent weld fracture in a continuous processing line, thereby contributing significantly to increasing productivity.

### BRIEF DESCRIPTION OF THE DRAWINGS

FIG. 1 is a view showing one example of a laser cutting device used for a laser butt welding method according to aspects of the present invention.

FIG. 2 is a view illustrating a butted part in the laser butt welding according to aspects of the present invention.

FIG. 3 is a view showing one example of a laser-beam welding device used for the laser butt welding method according to aspects of the present invention.

FIG. 4 is a view illustrating the weaving of a laser beam in the butt laser welding according to aspects of the present invention.

FIG. 5 is a view illustrating one example of a method for weaving the laser beam.

FIG. 6 is a view schematically illustrating a cross-section of a laser-beam weld, with (a) being an example in which a minimum melting width w is larger than a width a of a butted part, and (b) being an example in which the minimum melting width w is less than the width a of the butted part.

FIG. 7 is a view illustrating a welding method in a case where there is a difference in sheet thickness between steel sheets to be welded together.

FIG. 8 is a view illustrating a thickness h of a weld when two steel sheets to be welded together differ in sheet thickness.

### DETAILED DESCRIPTION OF EMBODIMENTS OF THE INVENTION

First, the basic technical idea according to aspects of the present invention will be described.

Conventionally, the formation of opposing end surfaces (cut surfaces) to be butt-welded of thin steel sheets having a small sheet thickness and a large width for which aspects of the present invention are directed has been performed by mechanical means, such as shearing process. Therefore, for example, when a shape defect, such as edge wave, medium elongation, or warp, has occurred in the steel sheets, it is difficult to cut the thin steel sheets straight in the sheet width direction, and a dimensional error occurs in the sheet width direction. Further, the cut end surfaces become irregular due to shear drop, burr, and the like. Thus, a problem arises that when the cut surfaces are placed in contact with each other and butted together, a gap is caused between the steel sheets and, moreover, it varies significantly in the sheet width direction.

The above-described problem of non-uniformity or variation of the gap width in the sheet width direction at the butted part of the steel sheets can be solved to some extent by forming the cut surfaces of the steel sheets to be butted together so as to have inclination angles in the same direction relative to a plane perpendicular to the surfaces of the steel sheets as disclosed in Patent Literature 7. However, the above-described conventional technology of Patent Literature 7 has been developed as a welding method suitable for a method of forming materials for automobile body parts, such as side members and pillars (so-called tailored blank method). Therefore, no consideration is given to a method of forming the cut surfaces to be butted together. As a result, the cut surfaces of the steel sheets to be butted together are not formed with high accuracy, resulting in a problem that it is difficult to produce a high-quality butt-weld joint.

To solve the above-described problems and form the cut surfaces of the steel sheets to be butted together with high accuracy, aspects of the present invention use non-contact laser cutting. Thus, regardless of the shapes of the thin steel sheets, cut surfaces can be formed straight in the sheet width direction with high accuracy. Moreover, laser cutting can extremely easily form cut surfaces so as to have inclination angles relative to the plane perpendicular to the surfaces of the steel sheets.

There is another problem that arises when the above-described technology of Patent Literature 7 is applied to thin steel sheets: It was found that when welding steel sheets with a relatively small sheet thickness, particularly thin steel sheets with a sheet thickness of 1.0 mm or less, by emitting a laser beam onto the butted part, underfill occurred at the weld due to burn-through, resulting in reduced mechanical strength of the weld.

To address this problem, the present inventors reviewed the inclination angle disclosed in Patent Literature 7. As a result, the present inventors found that to prevent burn-through in thin steel sheets with a sheet thickness of 3.0 mm or less, particularly thin steel sheets with a sheet thickness of 1.0 mm which were prone to burn-through, it was necessary to optimize the inclination angles θ of the cut surfaces to be butted together relative to the plane perpendicular to the surfaces of the steel sheets, specifically, to set the inclination angles θ to be more than 20°.

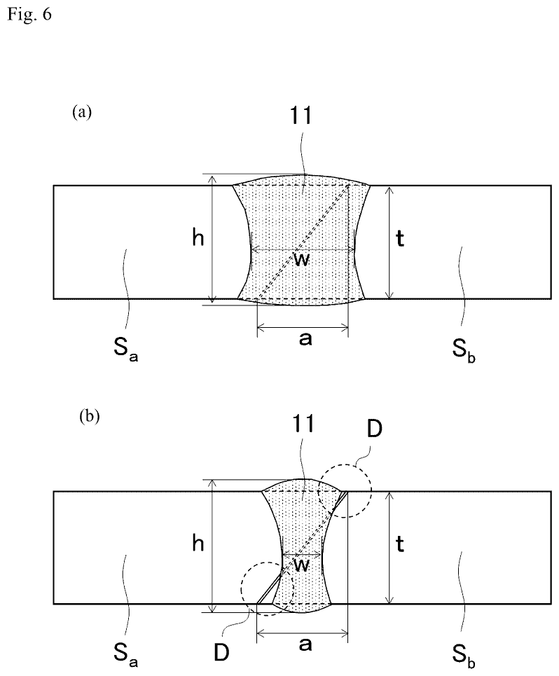

However, thus making the inclination angles θ larger leads to another problem that when the sheet thickness is large and the width a of the cut surfaces in the steel-sheet longitudinal direction (corresponding to the width of the butted part when the cut surfaces are overlapped in the form of a scarf joint) is large, an unmelted portion occurs at the butted part of the cut surfaces (for “unmelted portion,” see FIG. 6 (b) to be described later). Therefore, to completely prevent the unmelted portion, it is preferable that a minimum melting width w of the weld to be formed by laser beam welding be set to not less than 0.7 times the width a of the butted part in the steel-sheet longitudinal direction, i.e., the width in the steel-sheet longitudinal direction of the cut surfaces of the steel sheets to be butted together.

However, even at the same inclination angles θ of the cut surfaces, the width a in the steel-sheet longitudinal direction of the cut surfaces to be butted together becomes larger as the sheet thickness becomes larger. Therefore, simply emitting the laser beam in a straight line cannot increase the minimum melting width w of the weld, so that an unmelted portion occurs. When the melting width is increased by increasing the laser output to prevent the unmelted portion, spatter occurs, which is likely to lead to weld defects.

In the butt welding according to aspects of the present invention, therefore, it is preferable that the melting width be increased by emitting the laser beam onto the butted part to be welded while weaving the laser beam such that the irradiation trajectory has a spiral shape. Thus weaving the laser beam uniformizes the heat energy input into the weld, and can thereby reduce the occurrence of burn-through and spatter.

Aspects of the present invention have been developed based on the above-described technical idea.

Next, a laser-beam butt welding method according to aspects of the present invention will be specifically described using the drawings.

First, in the welding method according to aspects of the present invention, it is necessary to form end surfaces (cut surfaces) to be butted together of two steel sheets to be butt-welded by laser cutting so as to have inclination angles θ in the same direction relative to the plane perpendicular to the surfaces of the steel sheets as described above.

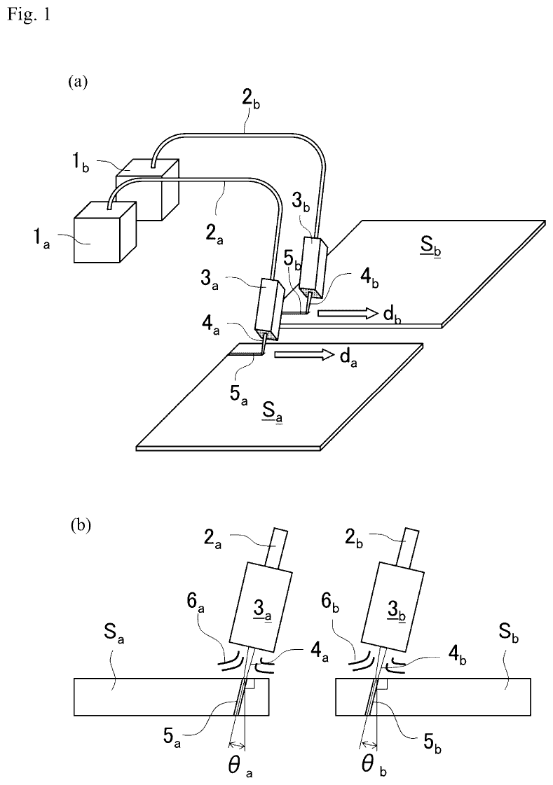

FIG. 1 are schematic views showing an example of a laser cutting device used to form these cut surfaces, with (a) being a perspective view showing the entire device and (b) being a side view as seen from a cutting direction.

As shown in FIGS. 1, this laser cutting device has two laser oscillators 1a, 1b that oscillate laser beams, transmission systems 2a, 2b that transmit the laser beams oscillated from the two oscillators, and processing heads 3a, 3b that are connected to the two transmission systems and that emit the laser beams onto steel sheets and thereby cut them. Laser beams 4a, 4b are emitted from the processing heads 3a, 3b onto two steel sheets Sa and Sb, respectively, that have been butted together, obliquely at an inclination angle θ relative to the plane perpendicular to the surfaces of the steel sheets, to thereby form cut surfaces 5a, 5b.

In FIG. 1, the two processing heads 3a, 3b cut the steel sheets by moving in the directions of da, db indicated in the drawing. To butt the cut surfaces of the two steel sheets together in the form of a scarf joint, inclination angles θa, θb of the cut surfaces of the steel sheets need to be in the same direction and be the same angle. It is preferable that during the cutting process, assist gasses 6a, 6b be sprayed from the processing heads 3a, 3b, respectively, to prevent oxidation of the cut surfaces.

While FIG. 1 shows the device that cuts two steel sheets at once using two laser-beam cutting machines, to cut down the equipment cost, the device may be simplified so as to have one laser beam oscillator and cut two steel sheets at once by splitting the laser beam into two using a spectroscopic mirror, a semi-transmissive filter, etc. (simultaneous bi-splitting), or by emitting the laser beam from two processing heads at different times (time splitting). Alternatively, two steel sheets may be cut by performing cutting twice using one laser-beam cutting machine.

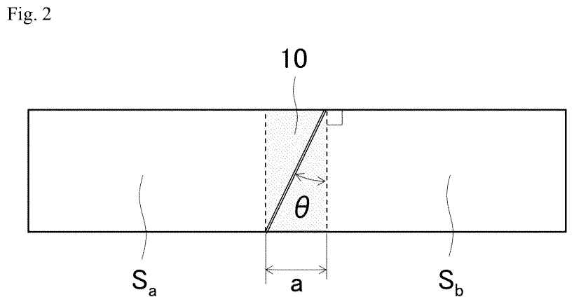

In the welding method according to aspects of the present invention, the cut surfaces of the two steel sheets formed so as to have the inclination angles θa, θb (also referred to as “0” as a representative of θa, θb) relative to the plane perpendicular to the surfaces of the steel sheets as described above are overlapped in a state of a scarf joint to thereby form a butted part 10 as shown in FIG. 2. Then, welding is performed by supplying a filler to and emitting a laser beam onto this butted part.

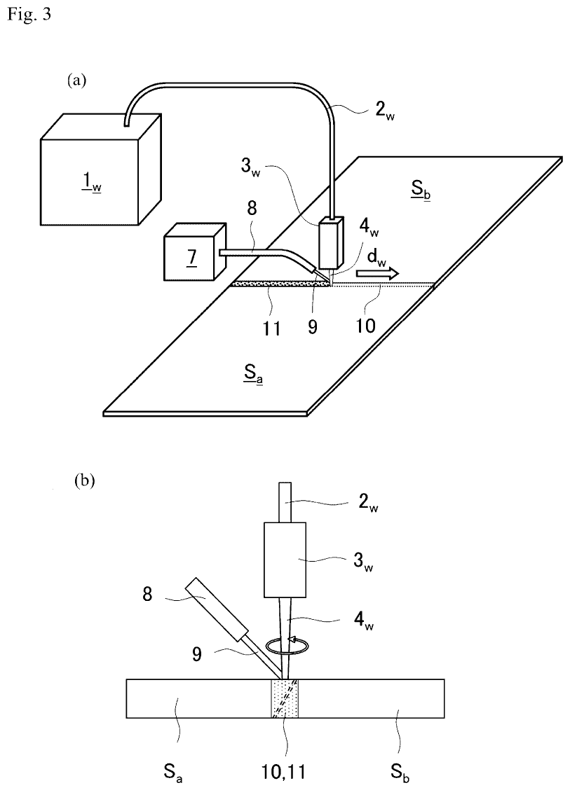

FIG. 3 are schematic views showing an example of a laser-beam welding device used for the above-described welding, with (a) being a perspective view showing the entire device and (b) being a side view as seen from the side of a welding forward direction.

The laser-beam welding device of FIG. 3 has a laser oscillator 1w that oscillates a laser beam, a transmission system 2w that transmits the laser beam, and a processing head 3w that welds the two butted steel sheets Sa, Sb together using the laser beam 4w. Further, a filler wire 9 is fed from a filler wire feed device 7 installed behind the processing head 3w through a feed channel 8 to the butted part of the two steel sheets Sa, Sb, and the butted part is irradiated with the laser beam 4w from the processing head 3w disposed above the butted part to thereby melt the butted part and the filler wire and form a weld 11. In FIG. 3 (b), for the convenience of description, the filler wire 9 is shown as being fed from an obliquely upper side. However, as long as the filler wire can be efficiently supplied to the butted part, the supply angle is not particularly limited in accordance with aspects of the present invention.

In this case, the laser beam emitted for the welding is emitted onto, as the target, a center portion of the butted part of the cut surfaces of the butted steel sheet Sa and steel sheet Sb. As shown in FIG. 3 (b), since the butted cut surfaces are formed so as to be inclined relative to the plane perpendicular to the surfaces of the steel sheets, the butted part has a width a in the steel-sheet longitudinal direction, which adds to the melting width required for welding. Therefore, if the width a of the butted part in the steel-sheet longitudinal direction becomes too large, simply emitting the laser beam by moving it in a straight line in the welding direction cannot completely melt the butted part.

For this reason, in accordance with aspects of the present invention, it is preferable that the laser beam be rotated around the butted part as the center and emitted to the butted part while being weaved such that the irradiation trajectory has a spiral shape.

While there are various methods for weaving the laser beam, for example, as shown in FIG. 5, a plurality of mirrors Ma, Mb may be incorporated inside the processing head 3w, and the laser beam 4w may be weaved as the mirrors operate in conjunction with the processing head 3w moving in the direction of the welding direction dw.

The laser beam oscillator 1w of the laser-beam welding device shown in FIG. 3 may be separate from the oscillators 1a, 1b of the laser-beam cutting device. However, to simplify the device and reduce the equipment cost, the oscillators of the laser-beam cutting device may be used as the laser beam oscillator 1w.

Next, the welding method according to aspects of the present invention that performs butt welding using the laser cutting device shown in FIG. 1 and the laser-beam welding device shown in FIG. 3 will be described.

Sheet thickness t of steel sheets: 0.1 to 3.0 mm

First, the thin steel sheets to which the butt welding according to aspects of the present invention is applied should have a sheet thickness t within a range of 0.1 to 3.0 mm. If the sheet thickness t is less than 0.1 mm, it is difficult to prevent burn-through at the butted part during welding, even when the irradiation conditions of the laser beam are adjusted. The sheet thickness t is preferably 0.4 mm or more. On the other hand, if the sheet thickness t exceeds 3.0 mm, since the cut surfaces to be butted together are formed so as to be inclined, a large melting width is required for welding, which in turn requires a high-output laser-beam welding device. Moreover, if the sheet thickness t exceeds 3.0 mm, burn-through is less likely to occur during welding and therefore there is no need to apply aspects of the present invention.

Since the welding method according to aspects of the present invention has an excellent effect for preventing burn-through during welding, to reap more of this effect, it is preferable that the method be applied to 1.0 mm or less thick steel sheets that are prone to burn-through.

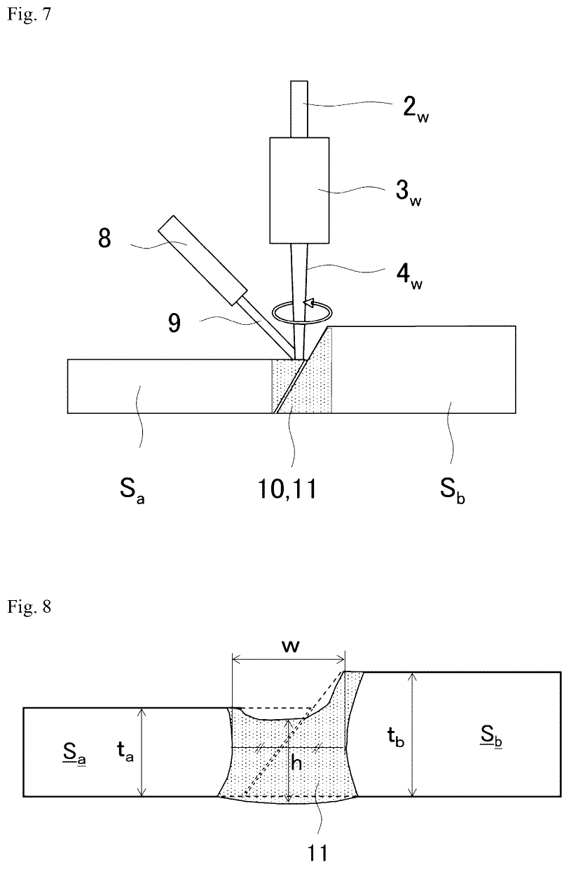

It is preferable that the two steel sheets to be butt-welded have the same sheet thickness. However, as long as the sheet thicknesses are within the above-described range of sheet thickness, a difference in sheet thickness between the two steel sheets that is not more than ⅓ of the steel sheet with a larger sheet thickness is allowable. It is preferable that welding in that case be performed, as shown in FIG. 7, with the centers of target positions of laser beam radiation and feeding of the filler wire lying at a central part in the width of the cut surface of the steel sheet with the larger sheet thickness.

Inclination angle θ of cut surfaces: exceeding 20° but not exceeding 60°

In the butt welding method according to aspects of the present invention, the angle θ at which the cut surfaces of the steel sheets to be butted together are inclined relative to the plane perpendicular to the surfaces of the steel sheets needs to be within a range of exceeding 20° but not exceeding 60°. If the inclination angle θ is 20° or less, in steel sheets with a sheet thickness of 3.0 mm or less, particularly steel sheets with a sheet thickness of 1.0 mm or less, the width of overlap of the two steel sheets at the butted part is so small that even when the cut surfaces are placed in contact with each other and butted together, a gap is left between the steel sheets and burn-through is likely to occur. On the other hand, if the inclination angle θ of the cut surfaces exceeds 60°, the width a of the butted part where the two steel sheets are overlapped becomes conversely too large, and accordingly the melting width required for welding becomes large. Thus, even when a high-output laser is used or the laser beam is weaved, the butted part is partially left unmelted after welding, leading to degradation of the soundness and the mechanical strength of the weld. The inclination angle θ is preferably within a range of 25 to 45°

While it is preferable that the inclination angles θ of the two steel sheets to be butted together be the same, a difference between the angles not more than 10° is allowable. However, also in this case, the inclination angles θ of both the steel sheets need to be within the range of aspects of the present invention of exceeding 20° but not exceeding 60°.

Width a of butted part: 3.0 mm or less

Even when the inclination angles θ of the cut surfaces of the steel sheets to be butted together are within the range of exceeding 20° but not exceeding 60°, as the sheet thicknesses of the steel sheets become larger, the width a of the butted part of the cut surfaces in the steel-sheet longitudinal direction becomes larger. However, if the width a exceeds the irradiation width of the laser beam, the butted part is left unmelted after welding even when the irradiation range is expanded by weaving the laser beam. When the melting width is increased by increasing the weaving width of the laser beam, not only burn-through conversely is more likely to occur but also a high-output laser becomes necessary. Therefore, the width a of the butted part in the steel-sheet longitudinal direction should be 3.0 mm or less. The width a is preferably 2.0 mm or less From the viewpoint of preventing burn-through at the butted part, it is preferable that the lower limit of the width a of the butted part be about 0.4 mm.

Weaving width of laser beam: 2.5 mm or less

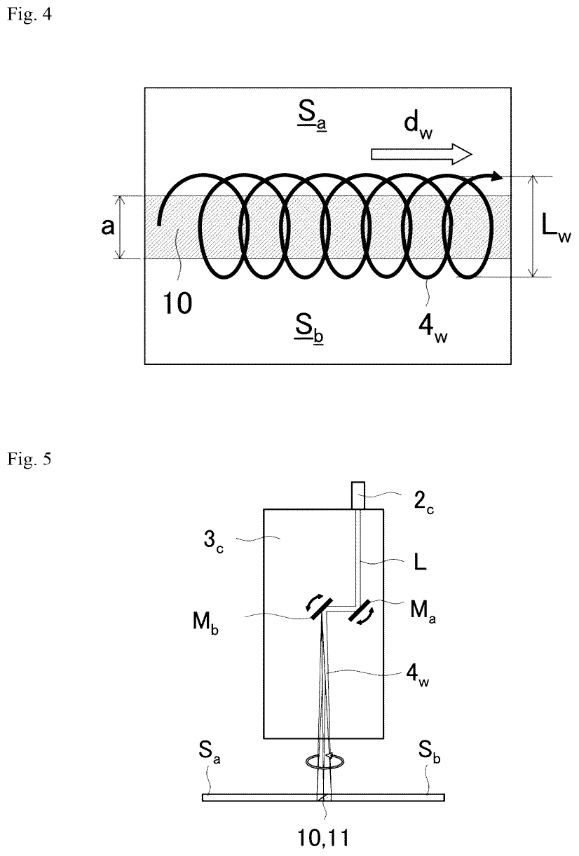

FIG. 6 is a view schematically showing a cross-section of the weld formed by the laser-beam welding method according to aspects of the present invention. As described above, in the welding method according to aspects of the present invention, it is preferable that the minimum melting width w of the weld be set to be not less than 0.7 times the width a of the butted part as shown in FIG. 6 (a). This is because if the minimum melting width w of the weld is less than 0.7 times the width a of the butted part, an unmelted portion D occurs on both sides of the butted part as shown in FIG. 6 (b). To prevent this unmelted portion, it is effective to weave the laser beam emitted onto the weld as shown in FIG. 4. However, if a weaving width Lw is too large, the heat energy input per unit area decreases, which results in a decrease in the welding speed. Therefore, when using a laser with a maximum output of about 10 KW or less, it is preferable that the weaving width Lw of the laser beam be set to 2.5 mm or less. The weaving width Lw is preferably 1.0 mm or less. This Lw refers to a center-to-center distance of the laser beam at its maximum amplitude. Therefore, for example, when the beam diameter of the laser is 0.5 mm and the weaving width Lw of the laser beam is 2.5 mm, the irradiation width of the laser beam is 3.0 mm. The melting width of the weld is correlated with the irradiation width of the laser beam, but depends also on the output of the laser beam, the welding speed, and the sheet thicknesses of the steel sheets, and therefore is not necessarily the same as the irradiation width.

To secure a favorable penetration shape and prevent the occurrence of an unmelted portion, it is preferable that the amount of heat input of the laser beam per unit sheet thickness and unit weld length be set to 10000 KJ/m² or more.

In accordance with aspects of the present invention, it is assumed that the cut surfaces of the two steel sheets to be butted together are to be placed in contact with each other, and the gap between the steel sheets is basically 0 (zero). However, as there is an irregularity in the surfaces of the cut surfaces, it is impossible to completely eliminate the gap, and a gap of 0.8 mm or less in a horizontal direction is allowable.

As for the filler wire, to prevent the weld metal from hardening, and fracturing in a later threading step, it is preferable to use a filler wire containing a low amount of carbon such as a C content of 0.15 mass % or less and having a tensile strength of 700 MPa or less. Further, it is desirable to adjust the wire diameter and the supply rate according to the sheet thicknesses of the steel sheets such that the thickness of the weld does not become too large.

### EXAMPLES

A laser-beam welding experiment was conducted using thin steel sheets that had the ingredient compositions shown in Table 1 with the balance composed of Fe and unavoidable impurities, and that each had a sheet thickness of one of 0.20 mm, 0.60 mm, 1.20 mm, 1.60 mm, and 2.30 mm and a sheet width of 1000 mm. Specifically, using the fiber-laser cutting device with a maximum output of 10 KW shown in FIG. 1, the end portions in the longitudinal direction of pairs of these steel sheets having the various ingredient compositions and sheet thicknesses were cut to form cut surfaces, with the inclination angle θ relative to the plane perpendicular to the surfaces of the steel sheets varied to 5°, 25°, 40°, 60°, and 70°. Then, the cut surfaces of each pair of steel sheets were butted together in the form of a scarf joint to form a butted part. Using the laser-beam welding device shown in FIG. 3, each pair of steel sheets were welded together along the entire width by supplying a filler wire to and emitting a laser beam onto this butted part under the conditions shown in Table 2. As the laser used for this welding, a fiber laser with a maximum output of 10 kW and a beam diameter of 0.5 mm was used, and the output and the welding speed were varied as shown in Table 2 according to the sheet thickness. When welding steel sheets having a sheet thickness of 1.20 mm or more, the laser beam was caused to be weaved such that the irradiation trajectory forms a spiral as shown in FIG. 4, and the weaving width was varied as shown in Table 2. To prevent the weld metal from hardening, and fracturing in the later threading step, it is preferable that a filler wire with a low carbon amount be used. In this Example, a wire equivalent to YGW11 specified in JIS Z 3312:2009 was used. As reference examples, a filler wire was not fed in welding some of the steel sheets.

TABLE 1

| Steel | Ingredient composition of steel sheet (mass %) | | | | | | | | | | | |
|---|---|---|---|---|---|---|---|---|---|---|---|---|
| type | C | Si | Mn | P | S | Al | N | Cr | Nb | Ti | B | V |
| A | 0.002 | <0.008 | 0.13 | 0.018 | 0.010 | 0.039 | 0.0023 | 0.038 | 0.002 | 0.034 | 0.0004 | 0.002 |
| B | 0.027 | <0.008 | 0.12 | 0.014 | 0.008 | 0.046 | 0.0034 | 0.031 | <0.002 | <0.001 | <0.0001 | <0.001 |
| C | 0.085 | 0.35 | 1.65 | 0.025 | 0.002 | 0.045 | 0.0035 | 0.035 | 0.025 | 0.001 | 0.0002 | 0.045 |
| D | 0.15 | 0.02 | 0.65 | 0.012 | 0.006 | 0.038 | 0.0045 | 0.029 | 0.002 | 0.001 | 0.0001 | 0.001 |
| E | 0.16 | <0.008 | 0.69 | 0.020 | 0.006 | 0.038 | 0.0035 | 0.011 | <0.002 | <0.001 | <0.0001 | 0.001 |

TABLE 2

| | | | | | Welding Conditions | | | | | | | |
|---|---|---|---|---|---|---|---|---|---|---|---|---|
| | | | Cut surface | | | | Welding | | | Input | Filler | |
| | Types of | Sheet | | Joint | Laser | Welding | beam | Weaving | | heat | wire | Filler wire |
| Test | steel | thickness | Inclination | width a | output | rate | diameter | width | Irradiation | amount | diameter | supply rate |
| No. | welded | t (mm) | angle θ(deg) | (mm) | (kW) | (m/min) | (mm) | L_{W} (mm) | width (mm) | (kJ/m²) | (mm) | (m/min) |
| 1 | Both A | 0.20 | 5 | 0.02 | 1.0 | 10.0 | 0.5 | 0.0 | 0.5 | 30000 | 0.4 | 1.0 |
| 2 | Both A | 0.20 | 25 | 0.09 | 1.0 | 10.0 | 0.5 | 0.0 | 0.5 | 30000 | 0.4 | 1.0 |
| 3 | Both A | 0.20 | 40 | 0.17 | 1.0 | 10.0 | 0.5 | 0.0 | 0.5 | 30000 | 0.4 | 1.0 |
| 4 | Both A | 0.20 | 60 | 0.35 | 1.0 | 10.0 | 0.5 | 0.0 | 0.5 | 30000 | 0.4 | 1.0 |
| 5 | Both A | 0.20 | 70 | 0.55 | 1.0 | 10.0 | 0.5 | 0.0 | 0.5 | 30000 | 0.4 | 1.0 |
| 6 | Both B | 0.60 | 5 | 0.05 | 1.0 | 8.0 | 0.5 | 0.0 | 0.5 | 12500 | 0.6 | 1.0 |
| 7 | Both B | 0.60 | 25 | 0.28 | 1.0 | 8.0 | 0.5 | 0.0 | 0.5 | 12500 | 0.6 | 1.0 |
| 8 | Both B | 0.60 | 40 | 0.50 | 1.0 | 8.0 | 0.5 | 0.0 | 0.5 | 12500 | 0.6 | 1.0 |
| 9 | Both B | 0.60 | 60 | 1.04 | 1.0 | 8.0 | 0.5 | 0.0 | 0.5 | 12500 | 0.6 | 1.0 |
| 10 | Both B | 0.60 | 70 | 1.65 | 1.0 | 8.0 | 0.5 | 0.0 | 0.5 | 12500 | 0.6 | 1.0 |
| 11 | Both C | 1.20 | 5 | 0.10 | 1.5 | 6.0 | 0.5 | 1.0 | 1.5 | 12500 | 1.2 | 2.0 |
| 12 | Both C | 1.20 | 25 | 0.56 | 1.5 | 6.0 | 0.5 | 1.0 | 1.5 | 12500 | 1.2 | 2.0 |
| 13 | Both C | 1.20 | 40 | 1.01 | 1.5 | 6.0 | 0.5 | 1.0 | 1.5 | 12500 | 1.2 | 2.0 |
| 14 | Both C | 1.20 | 60 | 2.08 | 1.5 | 6.0 | 0.5 | 1.0 | 1.5 | 12500 | 1.2 | 2.0 |
| 15 | Both C | 1.20 | 70 | 3.30 | 1.5 | 6.0 | 0.5 | 1.0 | 1.5 | 12500 | 1.2 | 2.0 |
| 16 | Both D | 1.60 | 5 | 0.14 | 2.5 | 5.0 | 0.5 | 1.0 | 1.5 | 18750 | 1.2 | 3.0 |
| 17 | Both D | 1.60 | 25 | 0.75 | 2.5 | 5.0 | 0.5 | 1.0 | 1.5 | 18750 | 1.2 | 3.0 |
| 18 | Both D | 1.60 | 40 | 1.34 | 2.5 | 5.0 | 0.5 | 1.0 | 1.5 | 18750 | 1.2 | 3.0 |
| 19 | Both D | 1.60 | 60 | 2.77 | 2.5 | 5.0 | 0.5 | 1.0 | 1.5 | 18750 | 1.2 | 3.0 |
| 20 | Both D | 1.60 | 70 | 4.40 | 2.5 | 5.0 | 0.5 | 1.0 | 1.5 | 18750 | 1.2 | 3.0 |
| 21 | Both E | 2.30 | 5 | 0.20 | 4.0 | 4.0 | 0.5 | 2.0 | 2.5 | 26087 | 1.2 | 3.0 |
| 22 | Both E | 2.30 | 25 | 1.07 | 4.0 | 4.0 | 0.5 | 2.0 | 2.5 | 26087 | 1.2 | 3.0 |
| 23 | Both E | 2.30 | 40 | 1.93 | 4.0 | 4.0 | 0.5 | 2.0 | 2.5 | 26087 | 1.2 | 3.0 |
| 24 | Both E | 2.30 | 60 | 3.98 | 4.0 | 4.0 | 0.5 | 2.0 | 2.5 | 26087 | 1.2 | 3.0 |
| 25 | Both E | 2.30 | 70 | 6.32 | 4.0 | 4.0 | 0.5 | 2.0 | 2.5 | 26087 | 1.2 | 3.0 |
| 26 | C and D | 1.20 and | 25 | 0.56 | 2.5 | 5.0 | 0.5 | 1.0 | 1.5 | 21429 | 1.2 | 3.0 |
| | | 1.60 | | | | | | | | | | |
| 27 | D and E | 1.60 and | 25 | 0.75 | 4.0 | 4.0 | 0.5 | 2.0 | 2.5 | 30769 | 1.2 | 3.0 |
| | | 2.30 | | | | | | | | | | |
| 28 | Both C | 1.20 | 25 | 0.56 | 1.5 | 6.0 | 0.5 | 1.0 | 1.5 | 12500 | — | — |
| 29 | Both D | 1.60 | 25 | 0.75 | 2.5 | 5.0 | 0.5 | 1.0 | 1.5 | 18750 | — | — |

* The amount of heat input per unit sheet thickness and unit weld length of No. 26 and 27 were calculated using an average value of two different sheet thicknesses.

Next, the weld of each pair of steel sheets welded together as described above was subjected to the following evaluation tests.

### [Evaluation of External Appearance of Weld]

The weld was visually observed along the entire length to inspect for the presence/absence of burn-through and the presence/absence of underfill.

### [Evaluation of Weld Cross-Section]

Test specimens were taken from three positions of a start point, a middle point, and an end point of welding of the weld, and from a photograph of a cross-sectional macrostructure taken by an optical microscope, the minimum melting width w in the sheet thickness direction and the weld center thickness h in the weld cross-section as shown in FIG. 6 were measured, and whether there was an unmelted portion D in the weld cross-section as shown in FIG. 6 (b) was examined. Here, as shown in FIG. 8, the weld center thickness h is the thickness of the weld metal at the center in the width of the portion of the weld with the minimum melting width w.

### [Evaluation of Strength Characteristics of Weld]

### <Erichsen Test>

Disc-shaped test specimens measuring 90 mm across were taken from the three positions of the start point, the middle point, and the end point of welding of the weld so as to include the weld at the center, and an Erichsen test (bulging test) was conducted in accordance with JIS Z 2247:2006. Welds in which fracture of the weld metal along the welding direction had not occurred at any point were evaluated as pass (circle), and those in which fracture of the weld metal had occurred at even one point were evaluated as fail (cross).

### <Tensile Test>

No. 5 tensile test specimens as specified in JIS Z 2241:2011 were taken from the three positions of the start point, the middle point, and the end point of welding of the weld so as to include the weld at a central portion of a parallel part in the longitudinal direction, and a tensile test was conducted. Welds in which all fractures were in the base metal were evaluated as pass (circle), and those in which fracture had occurred at even one point other than the base metal were evaluated as fail (cross).

The results of these evaluation tests are shown in Table 3. These results demonstrate the following:
The welds that were welded under conditions complying with aspects of the present invention are free of burn-through, underfill, and unmelted portion, and have excellent mechanical strength.

By contrast, in the welds of Nos. 1, 6, 11, 16, and 21 in which the inclination angles θ of the cut surfaces are less than the range of the present invention, burn-through occurred at the butted part, resulting in underfill and poor mechanical strength.

Conversely, in the welds of Nos. 5 and 10 in which the inclination angles θ of the cut surfaces are larger than the range of the present invention, again, burn-through occurred due to the sheet thicknesses being less than 1.0 mm, resulting in underfill and poor mechanical strength. Similarly, in the welds of Nos. 15, 20, and 25 in which the inclination angles θ are less than the range of the present invention, burn-through did not occur owing to the sheet thicknesses being more than 1.0 mm, but an unmelted portion occurred at the welds due to the large butted part width, resulting in poor mechanical strength.

The same is true for No. 24, in which, although the inclination angle θ is within the range of aspects of the present invention, an unmelted portion occurred at the butted part due to the butted part width exceeding 3.0 mm.

In No. 14 and 19, an unmelted portion occurred locally, but the extent was so extremely small that the results of the Erichsen test and the tensile test were not influenced.

TABLE 3

| | Weld Evaluation | | | | | | | | |
|---|---|---|---|---|---|---|---|---|---|
| | | | Minimum | | Weld center | | Erichsen | Tensile | |
| Test | Burn- | | melting | | thickness | Unmelted | test | test | |
| No. | through | Underfill | width w(mm) | w/a | h (mm) | cut surface | result | result | Remarks |
| 1 | Presence | Presence | 0.6 | 34.3 | 0.1 | Absence | X | X | Comparative Example |
| 2 | Absence | Absence | 0.6 | 6.4 | 0.2 | Absence | ◯ | ◯ | Invention Example |
| 3 | Absence | Absence | 0.6 | 3.6 | 0.2 | Absence | ◯ | ◯ | Invention Example |
| 4 | Absence | Absence | 0.6 | 1.7 | 0.2 | Absence | ◯ | ◯ | Invention Example |
| 5 | Presence | Presence | 0.6 | 1.1 | 0.1 | Absence | X | X | Comparative Example |
| 6 | Presence | Presence | 0.8 | 15.2 | 0.4 | Absence | X | X | Comparative Example |
| 7 | Absence | Absence | 0.8 | 2.9 | 0.7 | Absence | ◯ | ◯ | Invention Example |
| 8 | Absence | Absence | 0.8 | 1.6 | 0.7 | Absence | ◯ | ◯ | Invention Example |
| 9 | Absence | Absence | 0.8 | 0.8 | 0.7 | Absence | ◯ | ◯ | Invention Example |
| 10 | Presence | Presence | 0.8 | 0.5 | 0.4 | Absence | X | X | Comparative Example |
| 11 | Presence | Presence | 1.0 | 9.5 | 0.7 | Absence | X | X | Comparative Example |
| 12 | Absence | Absence | 1.1 | 2.0 | 1.3 | Absence | ◯ | ◯ | Invention Example |
| 13 | Absence | Absence | 1.1 | 1.1 | 1.3 | Absence | ◯ | ◯ | Invention Example |
| 14 | Absence | Absence | 1.1 | 0.5 | 1.3 | Presence(Slight) | ◯ | ◯ | Invention Example |
| 15 | Absence | Absence | 1.1 | 0.3 | 1.3 | Presence | X | X | Comparative Example |
| 16 | Presence | Presence | 1.4 | 10.0 | 0.9 | Absence | X | X | Comparative Example |
| 17 | Absence | Absence | 1.5 | 2.0 | 1.7 | Absence | ◯ | ◯ | Invention Example |
| 18 | Absence | Absence | 1.5 | 1.1 | 1.7 | Absence | ◯ | ◯ | Invention Example |
| 19 | Absence | Absence | 1.6 | 0.6 | 1.7 | Presence(Slight) | ◯ | ◯ | Invention Example |
| 20 | Absence | Absence | 1.6 | 0.4 | 1.7 | Presence | X | X | Comparative Example |
| 21 | Presence | Presence | 2.0 | 9.9 | 1.6 | Absence | X | X | Comparative Example |
| 22 | Absence | Absence | 2.2 | 2.1 | 2.4 | Absence | ◯ | ◯ | Invention Example |
| 23 | Absence | Absence | 2.4 | 1.2 | 2.4 | Absence | ◯ | ◯ | Invention Example |
| 24 | Absence | Absence | 2.3 | 0.6 | 2.4 | Presence | X | X | Comparative Example |
| 25 | Absence | Absence | 2.3 | 0.4 | 2.4 | Presence | X | X | Comparative Example |
| 26 | Absence | Absence | 1.6 | 2.9 | 1.4 | Absence | ◯ | ◯ | Invention Example |
| 27 | Absence | Absence | 2.3 | 3.1 | 1.8 | Absence | ◯ | ◯ | Invention Example |
| 28 | Absence | Absence | 1.1 | 2.0 | 1.1 | Absence | ◯ | ◯ | Reference Example |
| 29 | Absence | Absence | 1.5 | 2.0 | 1.5 | Absence | ◯ | ◯ | Reference Example |

### INDUSTRIAL APPLICABILITY

In the above description, laser beam welding of a tail end of a preceding coil and a leading end of a succeeding coil on the entry side of a continuous processing line has been described as an example. However, the technology of the present invention is not limited to such welding, and can also be suitably used to manufacture tailored blank materials, for example.

### REFERENCE SIGNS LIST

1a, 1b, 1w: Laser oscillator
2a, 2b, 2w: Transmission system
3a, 3b: Cutting processing head
3w: Welding processing head
4a, 4b: Cutting laser beam
4w: Welding laser beam
5a, 5b: Cut groove (cut part)
6a, 6b: Assist gas
7: Filler wire feed device
8: Feed channel
9: Filler wire
10: Butted part
11: Weld
Sa, Sb: Steel sheet
θa, θb, θ: Inclination angle
da, db: Cutting direction
dw: Welding direction
Ma, Mb: Mirror
t: Sheet thickness
a: Butted part width
h: Weld center thickness
w: Minimum melting width
Lw: Laser beam weaving width
D: Unmelted portion

1. A laser-beam butt welding method in which cut surfaces of two steel sheets each having a sheet thickness t of 0.1 to 3.0 mm are placed in contact with each other and butted together, and then the two steel sheets are welded together by feeding a filler to the butted part and emitting a laser beam onto the butted part so as to melt the filler and the steel sheets,
wherein the cut surfaces of the two steel sheets are formed by laser cutting so as to have inclination angles θ exceeding 20° but not exceeding 60° in the same direction relative to a plane perpendicular to surfaces of the steel sheets, and to have a width a of 3.0 mm or less in a steel-sheet longitudinal direction; and
then, the cut surfaces of the two steel sheets are butted together in a state of a scarf joint and welded together.

2. The laser-beam butt welding method according to claim 1, wherein
a minimum melting width w of a weld to be formed by the laser beam irradiation is set to be not less than 0.7 times the width a of the cut surfaces in the steel-sheet longitudinal direction.

3. The laser-beam butt welding method according to claim 1, wherein
the laser beam is emitted to the butted part of the butted steel sheets while being weaved such that an irradiation trajectory has a spiral shape.

4. The laser-beam butt welding method according to claim 3, wherein
a weaving width b of the laser beam is set to 2.5 mm or less.

5. The laser-beam butt welding method according to claim 4, wherein
an amount of heat input of the laser beam per unit sheet thickness and unit weld length is set to 10000 KJ/m² or more.

6. The laser-beam butt welding method according to claim 2, wherein the laser beam is emitted to the butted part of the butted steel sheets while being weaved such that an irradiation trajectory has a spiral shape.

7. The laser-beam butt welding method according to claim 6, wherein a weaving width b of the laser beam is set to 2.5 mm or less.

8. The laser-beam butt welding method according to claim 7, wherein an amount of heat input of the laser beam per unit sheet thickness and unit weld length is set to 10000 KJ/m² or more.
